(19) United States
(12) Patent Application Publication
(10) Pub. No.: US 2006/0100928 A1
(43) Pub. Date: May 11, 2006

(54) System and method for providing content to a mobile communication device

(76) Inventors: Robert Walczak JR., New York, NY (US); James R. Ziron, Amston, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 11/268,840

(22) Filed: Nov. 8, 2005

Related U.S. Application Data
(60) Provisional application No. 60/626,695, filed on Nov. 9, 2004.
(60) Provisional application No. 60/720,172, filed on Sep. 23, 2005.

(51) Int. Cl. G06Q 30/00

(52) U.S. Cl. 705/14

(57) ABSTRACT

A method for providing content to a mobile device from a third party advertising system operating in conjunction with the host server in response to requests for content from the mobile device, wherein the method comprises the steps of transferring the mobile session from the host server to the third party advertising system acting as a secondary gateway; analyzing the request for the content at the third party advertising system and initiating a request to a content server for the content on behalf of the mobile device; exhibiting advertising content on the display of the mobile device during the request for content on behalf of the mobile device; upon receipt of the requested content from the host server, creating a virtualized version of the requested content in order to retain the mobile session within the control of the third party advertising system; terminating exhibition of the advertising content and transmitting the virtualized form of the requested content to the mobile device. A system for providing such content is also provided.

### RELATED APPLICATIONS

This application claims the benefit of U.S. Provisional Application No. 60/626,695, filed Nov. 9, 2004 and U.S. Provisional Application No. 60/720,172, filed Sep. 23, 2005.

### BACKGROUND OF THF INVENTION

The present invention is directed to a system and methods for providing content to mobile communication devices, such as mobile phones by way of example and not limitation, and in particular, to a system and methods for providing advertisements during predetermined periods in delivery of requested content to the mobile communication device.

Systems and methodologies for providing content to a user while waiting for a service are well known. For example, U.S. Published Application No. 2002/0191775 to Boies et al. describes a method, program and system for providing customized information to a user waiting in a queue in a communications system, such as a user using a telephone who has been placed on hold. The customized information content is then presented to the user, either audibly (i.e. over a speaker) or visually (i.e. on a computer or cell phone display). Examples of the type of information content presented to the user include music clips based on caller preferences, local news, or advertisements.

In another example, U.S. Application Publication No. 2005/0038900 to Krassner et al. describes an Internet-based system and method for distributing interstitial advertisements on websites. As described, the system uses an Internet dispatcher server and a mass storage device containing one or more databases storing advertisement command files pertaining to placements of advertisements that are stored in an advertisement server.

U.S. Patents, such as U.S. Pat. Nos. 6,014,439 and 6,400,804, are also known to describe methods and systems for entertaining users in a queue or otherwise on hold.

However, as it relates to providing content to users of mobile communication devices, such as mobile phones for example and not limitation, it is believed that the state of the art has perceived deficiencies. For example, it is believed that the prior art does not provide content in an optimized way so as to minimize the wait time between web page downloads or optimally facilitate the setting up of advertising accounts, the configuration of ad campaigns and/or the monitoring of distribution statistics.

Accordingly, it is desirable to provide a system and methodologies that yet further the state of the art of overcoming the perceived deficiencies in the prior art and achieving the objectives set forth above and within the remainder of this document.

### SUMMARY AND OBJECTIVES OF THE INVENTION

Accordingly, it is an object of the present invention to provide a method and system for providing content to a mobile communication device in a way that does not extenuate the time between web page downloads.

Still another object of the present invention is to provide an intuitive user interface that facilitates the setting up of advertising accounts, configuration of ad campaigns, and/or monitoring of distribution statistics.

Yet another object of the present invention is to configure ads to be interactive thus permitting the ability to provide users with auto text responses capabilities, ability to receive text coupons and/or promotional offers, just to name but a few examples.

A further object of the present invention is to provide demographically customized ads for display to target specific genders, age groups and/or zip codes just to name a few potential groups by way of example and not limitation.

Yet another object of the present invention is to provide for targeted time distribution (e.g. such as in a flat line format (i.e. same number of ads each day), in an increasing/decreasing format (i.e. more or less ads as the campaign progresses) or bell curve format), improved ad setups to appear after a specific web page at specific times of the day or to deliver ads every predetermined number of pages so as to not overload the website with advertisements and/or to configure ads to only be delivered within specific range of web pages within a website.

Another object of the present invention is to provide for customized ad specifications, whether it be only text, images and or a combination thereof.

And yet another object of the present invention is to facilitate and improve the analysis of advertising campaigns.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

Therefore and generally speaking, the present invention is directed to a method for providing content to a mobile device from a third party advertising system operating in conjunction with the host server in response to requests for content from the mobile device, wherein the method comprises the steps of transferring the mobile session from the host server to the third party advertising system acting as a secondary gateway; analyzing the request for the content at the third party advertising system and initiating a request for the content to a content server on behalf of the mobile device; exhibiting advertising content on the display of the mobile device during the request for content on behalf of the mobile device; upon receipt of the requested content from the host server, creating a virtualized version of the requested content in order to retain the mobile session within the control of the third party advertising system; terminating exhibition of the advertising content and transmitting the virtualized form of the requested content to the mobile device.

A system for providing content to a mobile device from a third party advertising system operating in conjunction with the host server in response to requests for content from the mobile device is also provided and comprises a data store storing advertising content; means for receiving the mobile session from the host server, whereby the third party advertising system acts as a secondary gateway; means for analyzing the request for content from the mobile device and initiating a request to a content server for the content on behalf of the mobile device from the desired location; means for exhibiting advertising content on the display of the mobile device during the request for content from the content server; means for receiving the requested content from the content server and creating a virtualized version of the requested content by parsing the content returned from the content server and replacing any redirection links to additional content with links that point back to the third party advertising system, parsing the content and resolving any links to content assets, such as images, into fully qualified links that correctly point to the content server locations, and assigning an identifier to the page on the third party advertising system such that the virtual links in the content sent to the mobile device correspond to entries at the third party advertising system pointing to the actual content location; and means for terminating exhibition of the advertising content and transmitting the virtualized form of the requested content to the mobile device.

In another embodiment, the method for providing content to a mobile device from a third party advertising system operating in conjunction with the host server in response to requests for content from the mobile device, comprises transferring the mobile session from the host server to the third party advertising system acting as a secondary gateway; analyzing the request for the content at the third party advertising system and initiating a request to a content server for the content on behalf of the mobile device; exhibiting advertising content on the display of the mobile device during the request for content on behalf of the mobile device; performing the scheduled download of requested content to the mobile device and exhibiting second advertising content together with the requested content.

### BRIEF DESCRIPTION OF THE DRAWINGS

For a fuller understanding of the invention, reference is had to the following description taken in connection with the accompanying figures, in which:

FIG. 1 depicts a system gateway process flow for a particular sequence of steps in accordance with the present invention;

FIG. 2 is a flow diagram of a system for providing content to a mobile communication device in accordance with the present invention;

FIG. 3 is an exemplary advertisement content display in accordance with a first embodiment of the present invention; and

FIG. 4 is an exemplary display of advertising content in accordance with a second embodiment of the present invention.

### DETAILED DESCRIPTION OF THE PREFERRED EMBODIMENTS

First, it is to be understood that the subject matter of U.S. Provisional Application Ser. Nos. 60/626,695 and 60/720,172 are incorporated by reference as if fully set forth herein. Therefore, details that are already disclosed in said applications need not be repeated herein.

As a general overview, the present invention is designed to facilitate new advertising delivery methods for web services, and mobile web services in particular. To that end, the present invention provides in one embodiment an improved delivery of “interstitial” ads as well as a second embodiment that delivers a novel “2-step” advertisement that comprises a combination of an “interstitial ad” with a traditional “banner” ad that follows on the requested content page itself, maximizing ad exposure time. In accordance with known nomenclature, “interstitial ads” appear between web pages, in the slack time during the download of the requested page.

In order to facilitate the ad delivery process, the present invention comprises a server, generally indicated at 100, that acts as a secondary gateway in the browser session (the first being the actual ISP or other WAP gateway). Details of the preferred system 100 construction will be disclosed below. As will be appreciated, utilization of the present invention injects the minimum processing possible into the browser session, thus minimizing impact on the user experience.

Generally speaking, upon access of the server hosting the WAP site by a subscriber, a detection script identifies whether the server is being accessed by a mobile communication device (e.g. mobile phone or other wireless unit). If the Script identifies the browser as a PC (i.e. or otherwise a non-mobile unit), then the subscriber is sent to the HTML site in accordance with known protocols. If on the other hand, it is determined that the device is a mobile unit, the subscriber is sent to the WAP Site where a session manager starts a session between the mobile device and the WAP site.

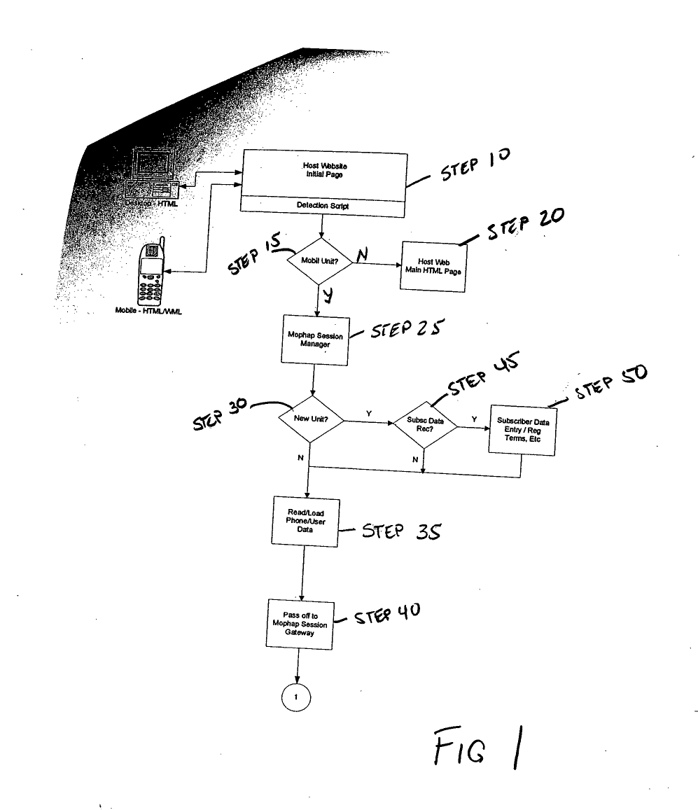

Reference is thus made to FIG. 1 which illustrates a general operational process flow of the aforementioned sequence. A mobile web user's connection is first detected (step 10) by the host web server using a script that detects mobile browsers as opposed to standard desktop web browsers. As indicated above, desktop browsers are sent to the normal content (steps 15, 20), while mobile browsers are redirected through system 100, on their way to the appropriate HTML or WAP content (steps 15, 25).

At step 30, the Session Manager detects whether the mobile unit is a new unit or one that already has a profile established in a database of the Session Manager. If the mobile unit is in the database then the unit and its information are passed off to the session gateway (steps 35, 40). However, if the profile is not in the database then a profile is established via asking the subscriber for information such as her age, gender & zip code via a WAP page that is designed to be filled out as a form. This profile information may then be passed to the session gateway and the web surfing/ad serving session begins (steps 45, 50).

It should also be understood that system 100 queries the browser for the unique phone ID (a “UPID”, which contains no personal user data) as well as phone characteristics such as screen size, image types supported, etc. System 100 may or may not be configured to provide a screen for the user to create a screen name and password, which can be required or optional. It may also be configured to request generic user information, specifically sex, age range (e.g. under 18, 18-25, etc.) and zip code. This data would typically be used for demographically targeted advertising. During this initial contact, system 100 will recognize “UPIDs” it has seen before and transfer directly to the desired web page.

As will be set forth in greater detail below, as the user navigates the Web, system 100 will, based on the configuration options set, insert advertising content based on the configuration set by the content provider. The ads may be “interstitial” ads, “banner” ads or “2-step” ads, which are essentially a combination of an “interstitial” and “banner” ad that are matched to provide an extended ad presence. Configuration options also control the frequency of ad distribution (after every page or every N pages).

Once the user enters the web content “portal” of the provider, system 100 can continue to serve ads until the browser session ends or the user leaves the provider's portal, depending on configuration. This is accomplished by “virtualizing” content redirection links to point back to the gateway of system 100, details of which will be disclosed further below.

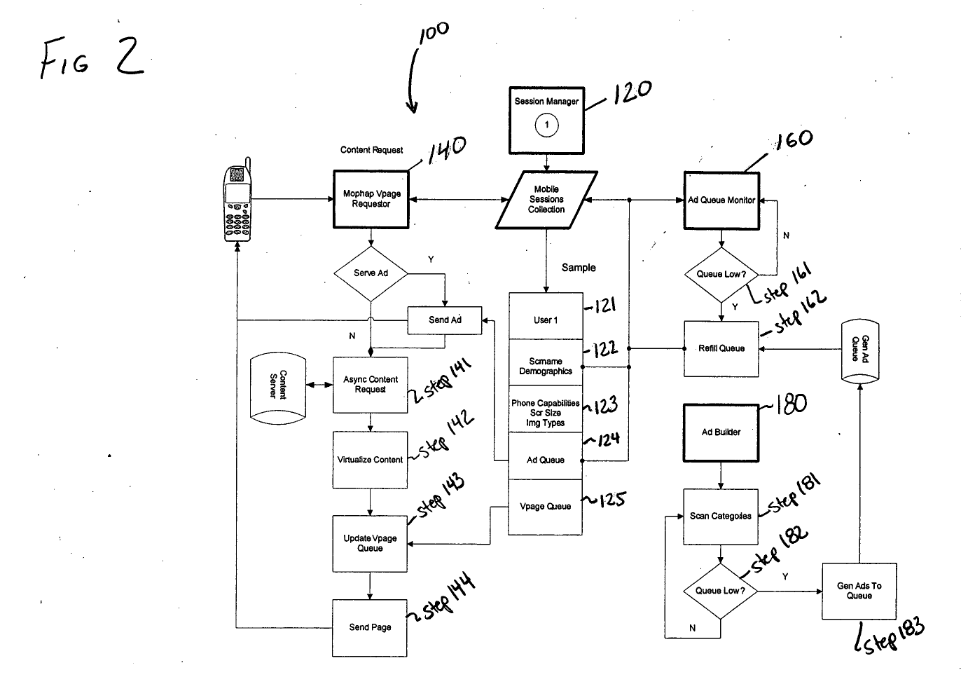

However, reference is first made to FIG. 2 for a detailed disclosure of a preferred embodiment of system 100, which comprises the flow and system constructed in accordance with the present invention. It should be understood that the preferred implementation is comprised of a set of discrete components. These components divide the workload of the system in a way that minimizes overhead and in effect reduces the time delay on the system in serving ads while obtaining the desired content for the mobile user. System 100 is preferably deployed among several servers. One server is the main database and administrative server (Server 1, encompassing Steps 120-125, 160-162 and 180-183 in FIG. 2).

Generally speaking, Server 1 is responsible for the central database repository, which holds host advertising accounts, ad promotion control data (dates/times for serving ads, whether demographics are desired, etc. as defined by the Ad Manager user interface as well as the actual ad content itself. It also holds the resulting statistical information on the number of ads served, the number of ads ‘clicked on’, etc.

The Ad Manager user interface is preferably an external management application (i.e. not part of the runtime system) that allows for creating advertising promotions and defining the actual ad content (text and/or image, whether the ad is interstitial, banner or 2-step, etc.). The actual ad content may need to be rendered in several formats, to suit the basic characteristics of the mobile device (the general screen size and image types supported by the device will dictate the necessary format of the ad). The ad is rendered into several formats when it is created in the Ad Manager UI. Thus, the need to incur overhead at session runtime in generating the actual advertisement is essentially if not fully eliminated.

System 100 comprises User Session Manager 120, which manages a collection of session data objects for the browser sessions in progress. The Session object for a session would typically contain any user-specific data (e.g. objects 121, 122, 123) system 100 may be required to track (although not typically user-identifiable data) as well as the Ad Queue (object 124) and Virtual Page Queue (object 125) for that session. Session objects are shared by the Content Request and Ad Queue management code. Specifically, session manager 120 holds session data for the mobile phones (note that this can be coordinated across multiple servers as well if necessary in high traffic situations). This allows the session data to be shared among the actual mobile content servers and the components that manage the advertising. Session data includes the mobile device capabilities (screen size, image types supported, etc.), the individual ad queues for each mobile session, and any demographic-related data that may be known or acquired via subscription requirements that may have been imposed.

A Content (VPage) Requestor 140 controls the process of initiating an asynchronous request (step 141) for content from the host server and serving ads from the session ad queue until the request is complete. The requested content is “virtualized” (step 142) in a manner disclosed below, and sent to the mobile unit (steps 143, 144).

An Ad Queue Manager 160 is responsible for scanning the Session Ad Queues and refilling the queue with new ads when necessary (steps 161, 162). Since the data for the current session holds demographic data (if used), Ad Queue Manager 160 has the ability to select ads by demographic classification if an Ad Generator 180, described below, is configured to generate them. If not, the general queue can be maintained in an order that facilitates easy searching. In particular, the Ad Queue Manager (“AQM”) 160 (steps 160 162) is responsible for monitoring the ad queues in individual sessions as managed by the Session Manager. Having access to any demographic-related data allows the “AQM” to select the appropriate ad references from the Ad Queue table maintained by Ad Generator 180 and use them to refill the session ad queue, deleting the selected ads from the Ad Queue as it ‘consumes’ them—which eventually causes the ‘Ad Generator’ to create more. In inserting ads into the session ad queues, the “AQM” retrieves the appropriate rendered format of the ad from the ad table (created by the Ad Manager UI) that matches the mobile device capabilities profile data in the session. This provides ‘pre-rendered’ ads in the ad queue, eliminating overhead from the ‘runtime’ servers—the ads are already in the appropriate format when placed in the queue. A session's ad queue is sized with a number of ads queued ahead of time based dynamically on the session's “consumption rate”.

The function of Ad Generator 180 is to create a queue of ads (steps 181, 182, 183) created from the available promotion data. If necessary (based on options set), Ad Generator 180 can create ads into classifications based on demographic or other criteria. This allows for quicker ad handling and more efficient use of processing time. The ads created here are selected by Ad Queue monitor 160. More particularly, ad generator 180 is responsible for generating the randomized ad queue that the system will select advertisements from. These random ads may be generated according to system options, such as “general non-demographic based ads” or ads targeted and specific demographic data. The determination of which ads to pick from is made by Ad Queue Manager 160. This randomized ‘queue’ is created in a table in the central database repository. The Ad Generator runs as an autonomous task (i.e. ‘service’) on the server and ensures a consistent supply of ads of any of the required categories. Again, having this ‘service’ running in this manner eliminates additional overhead from the servers actually managing the mobile sessions.

The other servers in system 100 are the “runtime” Servers (server 2 to N). These servers are implemented as “mirrors” of each other and are “load balanced” to distribute incoming mobile browser requests evenly among them. In the preferred embodiment, these remaining servers are responsible for the functionality carried out in steps 140-144.

The runtime servers are programmed for providing dynamic content, which provides for displaying the desired advertisement(s) which are replaced by the desired host content when ready. They respond to requests for host content, ‘virtualize’ that content and send the modified content result to the mobile user, inserting ads from the session ad queue as dictated by system operating parameters (after every page or every ‘N’ pages, as configured). Each server's sessions are managed by the Session Manager on Server 1, so that the session data is available to all required system components.

Typically, the initial redirection from the host server to system 100 might typically be created such that the system may identify it as the ‘entry point’ from the host system (i.e. the “start of a session”). This ‘entry point’ link may be resolved at the session start to the desired ‘home page’ for that host. This ‘entry point’ serves as a pre-defined ‘virtual page’ link that the system is capable of resolving. After this ‘entry point’, all ‘virtual page’ links are generated by the system. It should be noted that the preferred implementation supplies data as specified by the ad server that can uniquely identify the host. This should be considered a ‘general’ or ‘broad’ method that may incorporate (but not be limited to) data that identifies a host account within system 100.

One of the novel features of the present invention is the “virtualization” of the page links. That is, in accordance with the present invention, system 100 essentially acts as a “gateway” for the browser session, in the sense that all browser navigation passes through System 100. This allows for system 100 to insert ad content during requests for page content.

System 100 implements this “gateway” mode by “virtualizing” the content links to maintain data flow through its secondary gateway portal. The process of “virtualizing” the page links requires VPage Requestor 140 to parse the content returned from the host server and replace any redirection links with links that point back to the VPage Requestor. The page is assigned a “Virtual Page ID” within the session page queue and redirection links within the page are assigned “VLink IDs” that point to the actual redirection link. The “virtual link” in the content references the VPage and VLink IDs for the Session ID at System 100. Clicking the “VLink” in the content redirects to system 100 with the Session, VPage and VLink IDs, which are then resolved to the actual URL to request from the content host.

To enable caching of content on System 100, the content page can be assigned a “global VPage” ID tied to the Partner ID for a particular site. This ID can then be tied to the VPage queue in the session.

In particular, “virtualizing” a link involves replacing the actual content link to a new host page with a link that points back to system 100 instead. In order for this to function correctly, the original link must be saved on System 100. When all redirection links on the page have been “virtualized” in this manner, any link the user selects will send them back to System 100. In this way, system 100 has the ability to serve an ad while issuing the actual page request on behalf of the user. When the page request is completed, the new page is “virtualized” like the previous one and sent on to the user's browser.

Example Session:

| Host URL | Virtual URL |
|---|---|
| www.hostsite.com | www.myadsrv.com/ |
| | vpage.aspx?P=1&A=1&VP=0 |
| | New Session, sent from host on detecting |
| | mobile device. System 100 will redirect to |
| | URL associated with host information. |
| www.hostsite.com\ | www.myadsrv.com/ |
| news.htm | vpage.aspx?P=1&A=1&VP=1 |
| | User clicked ‘News’ link |
| www.hostsite.com\ | www.myadsrv.com/ |
| partners.htm | vpage.aspx?P=1&A=1&VP=2 |
| | User clicked ‘Partners’ link |
| www.othersite.com | www.othersite.com |
| | User clicked a link that leaves the host site |
| | and redirects to a partner site on which ads |
| | are not served. |
| www.myadsrv.com/ | www.myadsrv.com/ |
| vpage.aspx?P=1&A=1&VP=2 | vpage.aspx?P=1&A=1&VP=2 |
| | User selected ‘Back’ button in |
| | browser - link still points to ‘Partners’ |
| | page and ads can once again be served. |

Upon receiving a ‘virtual page’ link (‘entry point’ or as generated by system 100), the runtime server resolves the virtual link reference to the actual remote host link.

Just prior to issuing the request for the content, the runtime server determines if an ad should be served to the mobile device. The ad frequency is established by the Ad Manager UI. If an ad is ‘due’, the next ad from the session ad queue is selected and sent to the mobile device.

A request is made to the host on behalf of the mobile device. By ‘on behalf’, we mean that the request to the host has a request header that ‘impersonates’ the characteristics of the mobile device. Otherwise, the request would appear to be originating from a ‘desktop’ browser, as opposed to a ‘mobile’ one. Many content providers serve different content for desktop and mobile devices. This ensures the delivered content is that which the mobile device would have received directly. Note that this request is made ‘asynchronously’, meaning it is issued independent of the ad being sent to the mobile device.

When the content request is fulfilled by the host server, the runtime server parses the content for redirection links that it ‘virtualizes’ into the present invention's system links, storing the actual remote links for resolving in the future. These virtual links are created as ‘persistent’ virtual links, which means that each remote host link gets a unique virtual link that is stored in the database. This allows for a virtual link to be ‘bookmarked’ in the mobile browser and still be valid on a future session. Without ‘persistent’ links, the virtual links would only be valid for the current session. This behavior could be desired, however, depending on future requirements for system operation. In this case, they would take a slightly different form to indicate their ‘temporary’ nature.

It should be noted that a persistent link only needs to be ‘virtualized’ once. The system checks incoming links to see if they have already been handled via a simple database query and, if it already exists, the existing link is used.

The runtime server must also parse any references to content ‘assets’, such as images imbedded in the content. These links typically have a form that is ‘relative’ to the actual location of the content page on the host system. These ‘relative’ links would not function correctly “as is”, as the browser would assume the links were relative to the ‘virtual’ link's domain and not the real host server. The runtime server handles this by altering the ‘relative’ links into ‘fully qualified’ links (e.g.: “images/logo.gif” might be transformed into http://www.hostsite.com/images/logo.gif).

The properly translated content is sent to the mobile device, ‘bumping out’ the advertisement.

It is important to keep in mind that all URLs must be handled in this manner as long as system 100 desires to “hold on to” the session. Once a non-virtualized link is clicked, the connection with system 100 is cut in terms of serving ads. However, if the user were to select the “Back” button in their browser to return to a URL that had been “virtualized,” system 100 would have the opportunity to reacquire the session since the user is returning to the host site being managed. If system 100 is serving ads only within the domain(s) of the Partner/Account being serviced, these persistent URL references should not consume much space.

With the construction and arrangement of the present invention now disclosed above, reference is now made to several advantageous features and capabilities of the present invention.

Specifically, reference is now made to a second aspect of the present invention, namely an advertising format that that combines the functionality of a more traditional interstitial advertisement with an associated banner advertisement.

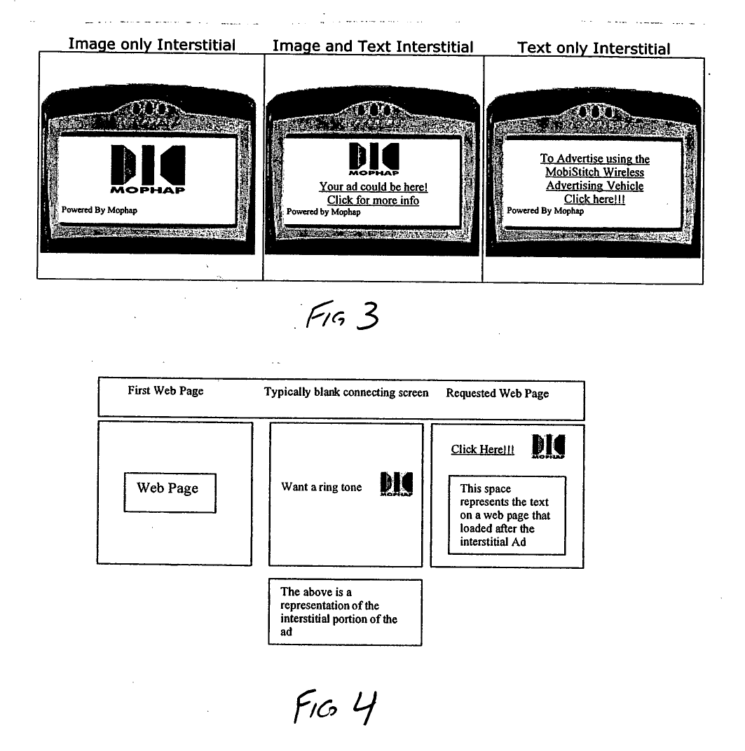

FIG. 4 illustrates a “2-Step” advertising format in accordance with this embodiment of the present invention. As illustrated and in accordance with the preferred configuration, the banner advertisements are ads that are displayed at the top of a mobile web page and take up, for example, 2-3 lines of space, and typically incorporate an image and/or text. However, as set forth above, the interstitial advertisement as set forth above preferably delivers a full screen image ad, image and text ad, or just text ad between mobile web pages while waiting for the following page to be downloaded as described both above and in the provisional applications identified above and incorporated by reference herein. FIG. 3 illustrates the display of an exemplary advertisement in accordance with the first embodiment of the present invention.

In accordance with this embodiment, these ads are combined to form a 2 step advertisement by displaying the same ad image between the web pages and once the following page is ready to load transferring that ad to the top of the loaded web page to display as a banner. Additionally the text that is displayed during the interstitial ad can change when displayed as a banner on the following page. It should also be noted that when the ad transfers to the top of the page the image is still available to be called on from the WAP gateway. Thus, the image doesn't have to load to the phone again and only the text has to reload because it changes.

The preferred structure to carry out this embodiment comprises a central serving application service provider (ASP) structure which interactively serves the 2-step ads, likewise within the web session and intermediate the website and the mobile communication device (e.g. mobile phone). One of the main advantages of an ASP model is that the ad Management system can be accessed from any computer with internet access, as an objective is to allow advertisers to logon and upload an advertisement though a Website.

Hereto, the 2-Step ad is provided by interactively processing each webpage that is requested by the mobile device's browser. What happens when the pages are processed is that the links on the pages are swapped out and indexed. The links that replace the ones on the web page are configured to send the next request from the mobile device back to the system instead of directly back to the website. When the system receives the request it matches that link up to the correlating indexed link. The system then serves the first part of the ad which is the interstitial ad and at the same time makes the request for the web page from the website. When the webpage is received by the system and is being processed at that point the banner ad portion of the 2-step ad is inserted.

It should now be appreciated that the present invention can deliver content, such as advertising content by way of example and not limitation, to a mobile communication device in a much more desirable format than that which is currently provided by the state of the art. For example, the present invention provides content to a mobile communication device in a way that does not extenuate the time between web page downloads. Additionally, the present invention provides a more intuitive user interface that facilitates the set up of advertising accounts, configures ad campaigns, and/or monitors distribution statistics. The ads can also be interactive thus permitting the ability to provide users with auto text responses, text coupons and/or promotional offers, by way of example. The present invention also provides a methodology and system for customization for display to target specific genders, age groups and/or zip codes, and/or time distribution.

However, other advantageous features are provided by the construction and methodologies set forth above. For example, the aforementioned embodiments, methodologies and construction provides for the configuring of ads to be interactive so that subscribers can click on them and either be redirected to an advertisers web page or have them directed to an SMS auto text response page. If they are redirected to an SMS auto text response page they may be prompted to fill in their phone number to receive text coupon or information about a promotional offer. For example, when consumers click on any of these ad units, they may link to either a pre-published WAP site or a jump page with special features, which may include but are not limited to: externally hosted branded WAP sites, jump page WAP sites with text and header images, direct response features including click-to-call, email opt-in, SMS opt-in and location finders (e.g. car dealers, stores, restaurants).

In another advantageous feature, a “continue button” feature is provided. Here, when a subscriber clicks on an ad and is sent to an advertisers website, system 100 interactively inserts a continue button link on their site that subscribers can click on to send them back to their originally requested WAP page. If the user hits “Back” it will take them back through the previous pages including ads that have displayed.

Additionally, while interstitial ads are configured to appear after a specific web page and banner ads are configured to appear on a specific web page, the novel “2-Step” ads disclosed and claimed herein set-up ads to display after a specific page and transfer to the top of a specific page in the web site.

Lastly, the present invention is written using ASP.NET, but the system could be accomplished using other development tools, such as PHP or Java.

Although described in the context of preferred embodiments, it should be realized that a number of modifications to these teachings may occur to one skilled in the art. Accordingly, it will be understood by those skilled in the art that changes in form and details may be made therein without departing from the scope and spirit of the invention.

It is also to be understood that the following claims are intended to cover all of the generic and specific features of the invention described herein and all statements of the scope of the invention which as a matter of language might fall therebetween.

What is claimed is:

1. A method for providing content to a mobile device from a third party advertising system operating in conjunction with the host server in response to requests for content from the mobile device, wherein the method comprises the steps of:
transferring the mobile session from the host server to the third party advertising system acting as a secondary gateway;
analyzing the request for the content at the third party advertising system and initiating a request to a content server for the content on behalf of the mobile device;
exhibiting advertising content on the display of the mobile device during the request for content on behalf of the mobile device;
upon receipt of the requested content from the host server, creating a virtualized version of the requested content in order to retain the mobile session within the control of the third party advertising system;
terminating exhibition of the advertising content and transmitting the virtualized form of the requested content to the mobile device.

2. The method as claimed in claim 1, wherein the step of creating a virtualized version of the requested content comprises the steps of:
parsing the content returned from the content server and replacing any redirection links to additional content with links that point back to the third party advertising system;
parsing the content and resolving any links to content assets, such as images, into fully qualified links that correctly point to the content server locations; and
assigning an identifier to the page on the third party advertising system such that the virtual links in the content sent to the mobile device correspond to entries at the third party advertising system pointing to the actual content location.

3. A system for providing content to a mobile device from a third party advertising system operating in conjunction with the host server in response to requests for content from the mobile device, comprising:
a data store storing advertising content;
means for receiving the mobile session from the host server, whereby the third party advertising system acts as a secondary gateway;
means for analyzing the request for content from the mobile device and initiating a request to a content server for the content on behalf of the mobile device;
means for exhibiting advertising content on the display of the mobile device during the request for content from the content server;
means for receiving the requested content from the content server and creating a virtualized version of the requested content by parsing the content returned from the content server and replacing any redirection links to additional content with links that point back to the third party advertising system, parsing the content and resolving any links to content assets, such as images into fully qualified links that correctly point to the content server locations, and assigning an identifier to the page on the third party advertising system such that the virtual links in the content sent to the mobile device correspond to entries at the third party advertising system pointing to the actual content location; and
means for terminating exhibition of the advertising content and transmitting the virtualized form of the requested content to the mobile device.

4. The system as claimed in claim 3, wherein at least a portion of the advertising content is prepared by or for a company offering specific products or services to users of the mobile device.

5. The method as claimed in claim 1, including the step of performing the scheduled download of requested content to the mobile device and exhibiting second advertising content together with the requested content.

6. A method for providing content to a mobile device from a third party advertising system operating in conjunction with the host server in response to requests for content from the mobile device, comprising:
transferring the mobile session from the host server to the third party advertising system acting as a secondary gateway;
analyzing the request for the content at the third party advertising system and initiating a request to a content server for the content on behalf of the mobile device;
exhibiting advertising content on the display of the mobile device during the request for content on behalf of the mobile device;
performing the scheduled download of requested content to the mobile device and exhibiting second advertising content together with the requested content.

7. The method as claimed in claim 6, wherein upon receipt of the requested content from the host server, creating a virtualized version of the requested content in order to retain the mobile session within the control of the third party advertising system; and
terminating exhibition of the advertising content and transmitting the virtualized form of the requested content.

8. The method as claimed in claim 7, wherein the step of creating a virtualized version of the requested content comprises the steps of:
parsing the content returned from the content server and replacing any redirection links to additional content with links that point back to the third party advertising system;
parsing the content and resolving any links to content assets, such as images into fully qualified links that correctly point to the content server locations; and
assigning an identifier to the page on the third party advertising system such that the virtual links in the content sent to the mobile device correspond to entries at the third party advertising system pointing to the actual content location.

9. The method as claimed in claim 6, wherein at least a portion of the first advertising content is comprised of custom advertising content prepared by or for a company offering specific products or services to users of the mobile device.

10. The method of claim 9, wherein at least a portion of the second advertising content is comprised of custom advertising content prepared by or for the same company as set forth in claim 9.

11. The method of claim 6, wherein the first and second advertising contents are identical.

12. The method of claim 6, wherein the first and second advertising contents are related to the same product or service.
